(19) United States
(12) Patent Application Publication
(10) Pub. No.: US 2008/0289703 A1
(43) Pub. Date: Nov. 27, 2008

(54) Hydraulic Check Valve Assembly

(75) Inventors: Robert Penzone, JR., Lawrenceville, PA (US); Aric Linza, Olean, NY (US)

Correspondence Address: BORGWARNER INC.;c/o Brown & Michaels, PC, 400 M&T Bank Building, 118 N. Tioga Street, Ithaca, NY, 14850, US

(73) Assignee: BorgWarner Inc., Auburn Hills, MI (US)

(21) Appl. No.: 12/092,594

(22) PCT Filed: Nov. 8, 2006
(86) PCT No.: PCT/US06/60648

§ 371 Date: May 5, 2008

Related U.S. Application Data
(60) Provisional application No. 60/736,614, filed on Nov. 14, 2005.

(51) Int. Cl. F16K 15/04

(52) U.S. Cl. 137/539

(57) ABSTRACT

A ball check valve for use in a hydraulic chain tensioner. The ball check valve contains a check ball, a ball seat having a passage for the flow of hydraulic fluid, a coil spring to urge the check ball toward the ball seat and a retainer to house these components. The retainer has at least two peripheral walls along its longitudinal axis, each of which is either substantially planar or slightly convex so that the check ball contacts a single point on each peripheral wall as it travels between full compression of the coil spring and secure abutment with the ball seat. The gaps or openings between the peripheral walls minimize turbulence in the flow of hydraulic fluid.

### FIELD OF THE INVENTION

The invention pertains to the field of hydraulic tensioners used in continuous loop chain driven power transmission systems for internal combustion engines. More particularly, the invention pertains to the check valve that is an integral part of many hydraulic tensioners.

### DESCRIPTION OF RELATED ART

A hydraulic tensioner is used to control excessive movement in a power transmission chain, or similar power transmission device, as the chain travels between a plurality of sprockets. In a power transmission system, power is transmitted by the continuous loop chain from a driving sprocket, such as the drive shaft, to one or more driven sprockets, such as those that operate the camshafts. During varying power demands, part of the chain will be tight and part will be slack. Also, engine torque fluctuations will severely affect the amount of tension experienced by different strands of chain.

It is important to maintain a certain degree of tension in the chain to prevent noise, slippage or tooth jumping as in the case of a toothed chain. Prevention of such excessive movement is particularly important in the case of a chain driven camshaft, because the jumping of teeth at any of the sprockets can throw off the timing of the camshaft, which might cause severe damage to the engine or render it totally inoperative.

Over prolonged use, wear experienced by the components of the power transmission system can cause a decrease in chain tension. Also, wide variations in temperature and different coefficients of thermal expansion among the various parts of the engine can cause the chain tension to vary from excessively high to very low levels. Other factors that affect chain tension are torsional vibrations of the camshaft and crankshaft or the reverse rotation of the engine, such as during the stopping of the engine or in failed attempts at starting the engine. For these reasons, a mechanism is needed to either remove or mitigate the excessive tension on the tight strand of chain while ensuring that adequate tension is present on the slack strand of chain.

Hydraulic tensioners have become a desirable method of maintaining proper chain tension. Such devices are conventionally used in conjunction with a lever arm that pushes against the slack strand of chain to tighten that strand. It must then retain rigidity when the chain tightens. A hydraulic tensioner typically contains a rod or cylinder acting as a piston, which is biased in the direction of the chain by a tensioner spring. The piston is housed within a cylindrically shaped piston housing, having an interior space that is open at the end facing the chain and is closed at the opposite end. The interior of the piston housing defines a pressure chamber and is connected to an exterior reservoir of hydraulic fluid. The size of the pressure chamber changes with the movement of the piston through the piston housing.

Valves are used to regulate the flow of hydraulic fluid into and out of the pressure chamber. Typically, the inlet valve is a ball check valve that opens to permit fluid to flow into the pressure chamber when the pressure inside the chamber has decreased, due to the movement of the piston toward the chain, during slack chain conditions. When the pressure inside the pressure chamber rises as a result of an increase in chain tension pushing back on the piston, the check valve closes, which prevents fluid from exiting the pressure chamber. This, in turn, prevents the piston from abruptly retracting away from the chain.

A ball check valve consists of a cup shaped housing which has an oil passage, a ball seat fitted into one end of the housing, a check ball, a coil spring to urge the check ball against the ball seat and a lid or cap at the end of the housing opposite from the ball seat to hold the coil spring in place. Typical problems that occur with ball check valves include the impedance in the flow of hydraulic fluid out from the interior of the housing as well as the unhindered movement of the check ball as it travels axially through the housing.

A typical prior art hydraulic tensioner as disclosed in U.S. Pat. No. 4,822,320 is shown in the sectional and perspective views of FIGS. 1 and 2. In this device a ratchet is employed in combination with a traditional hydraulic tensioner. A piston 12 having an opening at one end is slidably fitted within a housing 10. Spring 14 is positioned between the closed end of the piston 12 and the housing 10 to urge the piston 12 toward a pivoting lever arm 56 which applies tension to one strand of a continuous loop chain 54 between a drive sprocket 50 and a driven sprocket 52. Passages 26 and 27 are formed in housing 10 and, through a central hole in ball seat 28, supply hydraulic fluid to chamber 29 within piston 12. A check valve regulates the flow of hydraulic fluid into chamber 29 and consists of a check ball 30 which is biased toward the ball seat 28 by a coil spring S. The opposite end of coil spring S abuts a retainer R. The check valve permits the flow of hydraulic fluid into chamber 29 when slack conditions develop on the chain 54, thus urging the piston 12 to apply a tensioning force to lever arm 56. In this device, the retraction of the piston 12 is partially blocked by the stepwise engagement of the ratchet pawl 16 and a rack of teeth 12a on the piston 12.

During operation, when a load is applied to the piston of a hydraulic tensioner by a rise in the tension experienced by the chain, the fluid pressure in the piston's pressure chamber increases, which causes the ball in the ball check valve to firmly abut the ball seat to prevent the flow of additional hydraulic fluid into the pressure chamber. In some designs, small relief valves permit the fluid in the pressure chamber to slowly exit in response to increasing hydraulic pressure caused by increasing pressure exerted on the piston by a tightening chain. By releasing hydraulic fluid from the chamber at a slower rate than it takes to fill the chamber via the ball check valve, the tensioner does not overreact to rapid fluctuations in chain tension.

One solution offered to expedite the rate of flow of hydraulic fluid into the piston's pressure chamber is disclosed in Japanese Patent Publication 2002-188697. In this publication, a ball check valve is shown in which a number of slits are formed or cut into the wall of the check valve housing, such that the sum of the areas defined by the slits exceeds the sum of the surface area of the peripheral wall elements. Six to eight slits are considered most desirable. This design improves the flow of hydraulic fluid from the ball check valve housing into the pressure chamber. However, the peripheral wall elements between the slits are formed in such a way as to provide an inner radius, when viewed in a cross-section down the axis of the check valve housing. The concave inner radius is designed to very closely correspond to the radius of the check ball. The correspondence of the inner radius of the peripheral wall elements and the radius of the check ball is intended to provide for a more “true” axial movement of the check ball as it traverses the axis of the check valve housing by eliminating lateral movement of the check ball. However, because of the tight machining tolerances that are required and the potential for the creation of burrs on the edges of the slits caused by a milling or piercing manufacturing operation, there is significant potential that the movement of the ball will be hindered, thus adversely affecting the timely pressurization of the pressure chamber and the efficient operation of the hydraulic tensioner. There is therefore a need for an improved ball check valve design that solves these problems, while at the same time not adding to the expense of the manufacturing of these components.

### SUMMARY OF THE INVENTION

The hydraulic check valve of the invention consists of a retainer having an open end, a substantially closed end, also known as a vertex, and at least two peripheral walls, the combination of which defines a hollow internal chamber. A first end of each of the peripheral walls is connected to a first end of each of the other peripheral walls to form the vertex. A space or gap is formed between each of the peripheral walls. The gaps extend from the vertex alongside the peripheral walls. At the opposite end of the retainer, the second ends of the peripheral walls flare substantially outward away from the longitudinal axis of the cylindrical chamber and join to form a continuous annular flange. The outer periphery of the annular flange is bent toward the open end of the retainer to create an internal circular recess.

Within the hollow internal chamber are a coil spring and a ball. One end of the coil spring abuts the inner surface of the vertex of the retainer and the other end of the coil spring abuts the ball. The open end of the retainer contains a generally disc shaped ball seat that is located in the internal circular recess. The peripheral diameter of the ball seat abuts the inner wall of the internal circular recess. The ball seat contains a centrally located passage to permit the flow of hydraulic fluid into the hollow internal chamber. The diameter of the opening is less than the diameter of the ball so that when the coil spring forcefully urges the ball against the ball seat, the passage is sealed to prevent the continued flow of hydraulic fluid.

The peripheral walls may be substantially planar or slightly convex so that the ball only contacts each wall at a single point on the inner surface of the wall. As the ball traverses between full abutment with the ball seat and full compression of the coil spring, at any point in its travel along the longitudinal axis of the retainer it is guided by no more than a single contact point with each peripheral wall. Extending one end of each of the gaps onto the surface of the vertex results in less impedance of the hydraulic fluid as it rapidly flows from the hollow internal chamber into the pressure chamber of the tensioner's piston housing.

### BRIEF DESCRIPTION OF THE DRAWINGS

FIG. 1 shows a sectional view of a prior art hydraulic tensioner that includes a ball check valve.

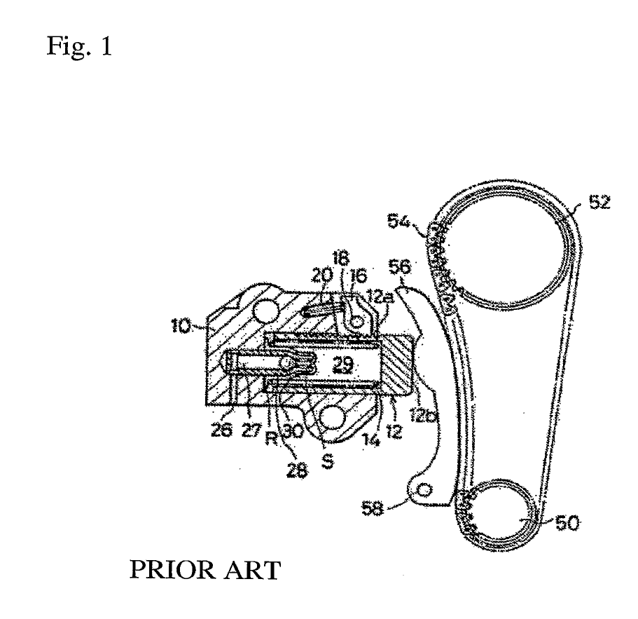

FIG. 2 shows a perspective view of various components, including the ball check valve, of the prior art tensioner of FIG. 1.

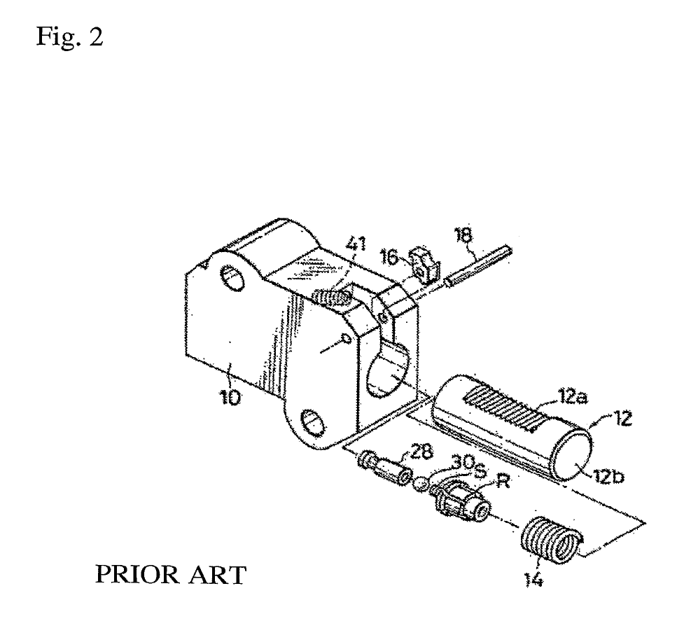

FIG. 3 shows a sectional view of the hydraulic check valve of the invention.

FIG. 4 shows a perspective view looking down of the vertex of the hydraulic check valve of FIG. 3.

FIG. 5 shows a sectional view of a first embodiment of a hydraulic check valve assembly of the invention, consisting of a hydraulic check valve and a seal housing.

FIG. 6 shows a sectional view of a second embodiment of a hydraulic check valve assembly of the invention.

FIG. 7 shows a sectional view of a third embodiment of a hydraulic check valve assembly of the invention.

FIG. 8 shows a sectional view of a fourth embodiment of a hydraulic check valve assembly of the invention.

FIG. 9 shows an isometric view of the retainer, ball and ball seat of the hydraulic check valve of FIG. 3.

FIG. 10 shows an isometric view of the first embodiment of the hydraulic check valve assembly of the invention.

### DETAILED DESCRIPTION OF THE INVENTION

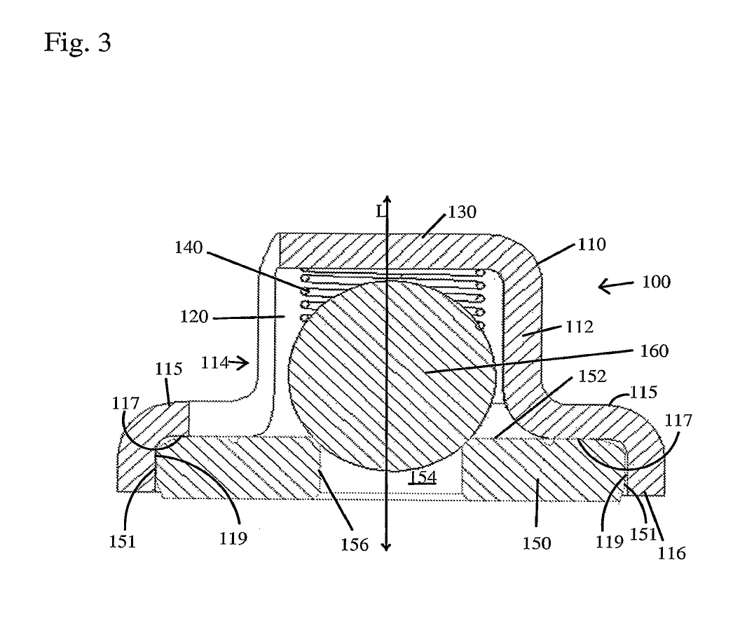

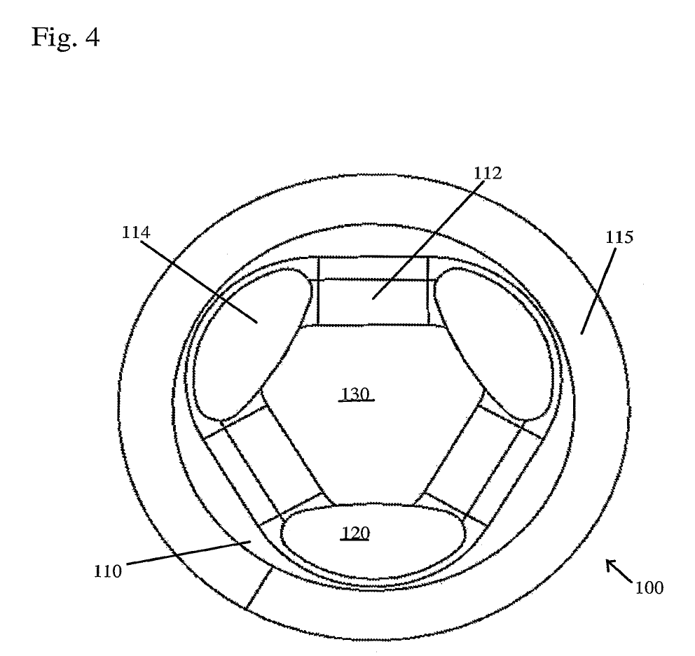

Referring to FIG. 3, the hydraulic check valve 100 of the present invention is shown in cross section. It is made up of a cup shaped retainer 110 having a longitudinal axis L. The retainer 110 has a substantially hollow internal chamber 120 that is defined by at least two peripheral walls, generally designated as 112, each extending parallel to the longitudinal axis L. The preferred embodiment of the retainer 110, it contains three peripheral walls 112. The open areas between the peripheral walls form gaps, generally designated as 114. The first end of the retainer 110 is enclosed and forms a vertex. The gaps may terminate before reaching the vertex 130 or they may extend onto the surface of the vertex. It is preferred that the gaps 114 terminate on the vertex 130. In the preferred embodiment, with three peripheral walls 112 and having the gaps terminate on the surface of the vertex, a substantially triangular shaped vertex 130 is formed. The triangular shape of the vertex 130 is best shown in FIGS. 4, 9 and 10.

Referring again to FIG. 3, the hollow internal chamber 120 contains a coil spring 140 and a ball 160. One end of the coil spring 140 abuts the internal surface of the vertex 130 and the other end of the coil spring 140 abuts the ball 160.

At the second end of the retainer 110, the peripheral walls 112 flare outward at a substantially perpendicular angle from the longitudinal axis L to form an annular flange 115. The lower portion of each of the gaps 114 only extend partially onto the annular flange thereby allowing the annular flange 115 to form a continuous circumference around the second end of the retainer 110. The annular flange 115 provides a seat for one end of a tensioner coil spring (not shown). The tensioner coil spring urges the piston of the hydraulic chain tensioner toward the chain in an internal combustion engine power transmission system. The outer periphery 116 of the second end of the retainer 110 is bent substantially perpendicularly from the annular flange 115 to form an internal radial flange 119. An internal surface 117 of annular flange 115 is located between the internal radial flange 119 and the hollow internal chamber 120.

A ball seat 150 having an inner annular surface 152 abuts the internal surface 117 of the annular flange 115 and an outer diameter 151 of the ball seat abuts the internal radial flange 119. The ball seat 150 is substantially circular and has a centrally located passage 154 whose inner diameter 156 is less than the diameter of ball 160. In operation, hydraulic fluid flows into the hollow internal chamber 120 through passage 154 when the pressure in the engine's hydraulic system is sufficient to overcome the force of the coil spring 140 which provides a continuous force to urge the ball 160 to securely abut the ball seat 150. When the force of the hydraulic pressure drops below the force exerted by the coil spring 160, the ball is urged by the coil spring 140 to securely seal the passage 154 of ball seat 150, which, in turn stops the flow of hydraulic fluid.

Since a ball check valve in a power transmission chain tensioner operates at a very high rate of speed, often approaching 300 hertz, the ball 160 must travel along the longitudinal axis L of the hollow internal chamber 120 between the points of full compression of the coil spring 140 and abutment with the ball seat 150 with little or no lateral movement. The lateral movement of the ball contributes undesirable turbulence in the flow of hydraulic fluid through the internal chamber 120. The peripheral walls 112 are either planar or slightly convex. The radius of the convex shaped peripheral wall is greater than the radius of the ball 160 so that the ball contacts the interior of each peripheral wall at no more than one point. Planar walls are most preferred. As is best shown in FIG. 4, the ball 160 is only allowed to contact the inner surface of each wall 112 at a single point along its longitudinal axis, at any point in time. As the ball 160 traverses between full abutment with the ball seat 150 and full compression of the coil spring 140 it is held to a true axially course because of the single point of contact with each peripheral wall.

In the preferred embodiment, when the upper portion of each of the gaps 114 extends onto the surface of the vertex 130 a substantially triangular shape is formed. This configuration substantially minimizes turbulence as the hydraulic fluid flows out of the hollow internal chamber 120 and into the pressure chamber of the tensioner piston. This provides for the more efficient operation of the hydraulic chain tensioner.

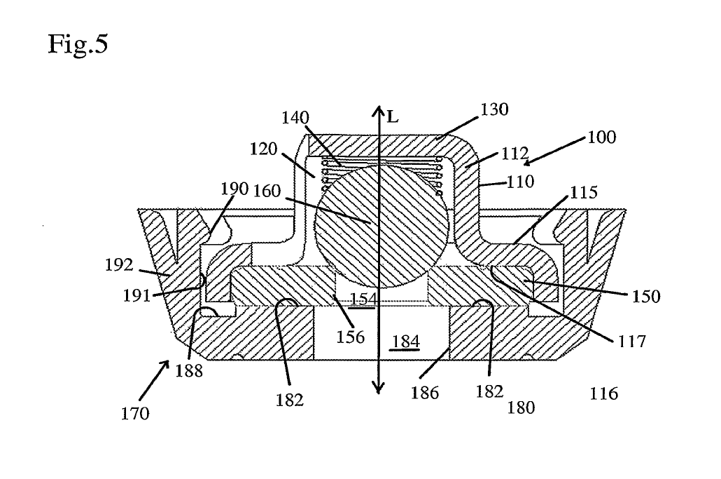

Referring to FIG. 5, the hydraulic check valve 100 is located within a seal housing 180 to form a first embodiment of the hydraulic check valve assembly 170. The seal housing 180 provides an annular sealing surface 182 that abuts an outer annular surface 153 of the ball seat 150 to form a sealing surface to prevent the unregulated flow of hydraulic fluid from an external source within the engine hydraulic fluid system, via passage 154, past the hollow internal chamber 120 and into the pressure chamber of the tensioner piston housing (not shown). The seal housing 180 has a centrally located circular passage 184 having a diameter 186 that is larger than the diameter 156 of passage 154 of the ball seat 150. The seal housing 180 is provided with an inner annular groove 188 having a diameter that corresponds to the diameter of the outer periphery 116 of the retainer 110. The outer periphery 116 does not abut the surface of the inner annular groove 188 in spite of being urged in that direction by the tensioner coil spring (not shown) which forcefully abuts annular flange 115. The inner annular groove 188 only operates as a guide to properly locate the retainer 110 within the seal housing 180.

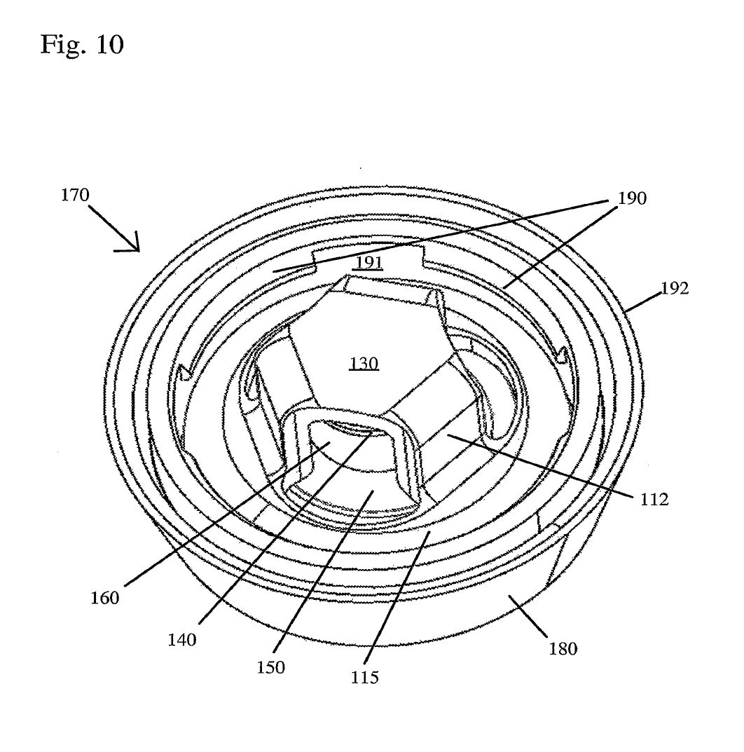

In the embodiment of the hydraulic check valve assembly 170 shown in FIG. 5, the hydraulic check valve 110 is loosely contained within seal housing 180 by an internal annular lip 190. Annular lip 190 is integral with the inner surface 191 of vertical wall 192 which extends around the circumference of the seal 180. Annular lip 190 may be continuous around the inner surface of vertical wall 192 or it may be partitioned into two or more separate segments. The segmented annular lip 190 is best shown in FIG. 10. The hydraulic check valve 100 is inserted into the seal 180 by forcing the outer periphery 116 of the retainer 110 past annular lip 190 to form check valve assembly 170. Vertical wall 192 flexes outward to permit the hydraulic check valve 100 to pass the annular lip 190. Once contained within the seal 180, the retainer 110 is free to move along the longitudinal axis L between annular groove 188 and annular lip 190. The force urging the secure abutment of the annular sealing surface 182 and the outer annular surface 153 of the ball seat 150 is provided by the tensioner spring (not shown) that abuts annular flange 115.

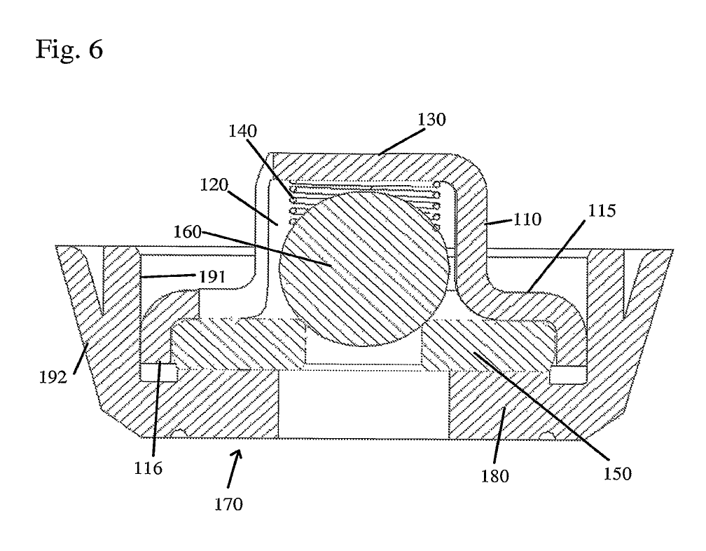

A second embodiment of the hydraulic check valve assembly 170 is shown in FIG. 6. The hydraulic check valve 110 is securely contained within seal housing 180 by creating an interference fit between retainer 110 and the inner surface 191 of vertical wall 192. In this embodiment, the diameter of the outer periphery 116 of the retainer 110 is slightly larger than the diameter of the inner surface 191 of the vertical wall 192 to enable the secure retention of the hydraulic check valve 100 within the seal housing 180.

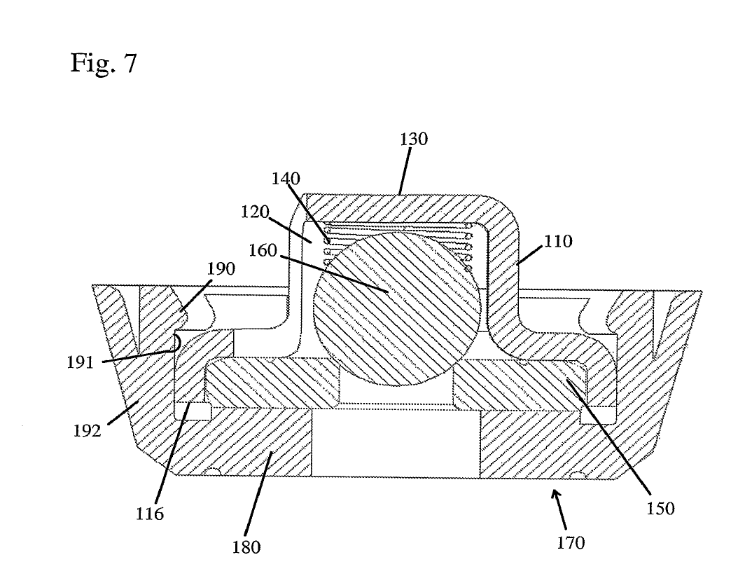

Referring to FIG. 7, a third embodiment of the hydraulic check valve assembly 170 is shown. This embodiment is a combination of the previous two embodiments in that the retainer 110 is secured to the seal housing 180 by an interference fit between the outer periphery 116 of the retainer and the inner surface 191 of the vertical wall 192. Furthermore, annular lip 192 is located on vertical wall 190 to provide additional means to retain the hydraulic check valve 100 within the seal housing 180.

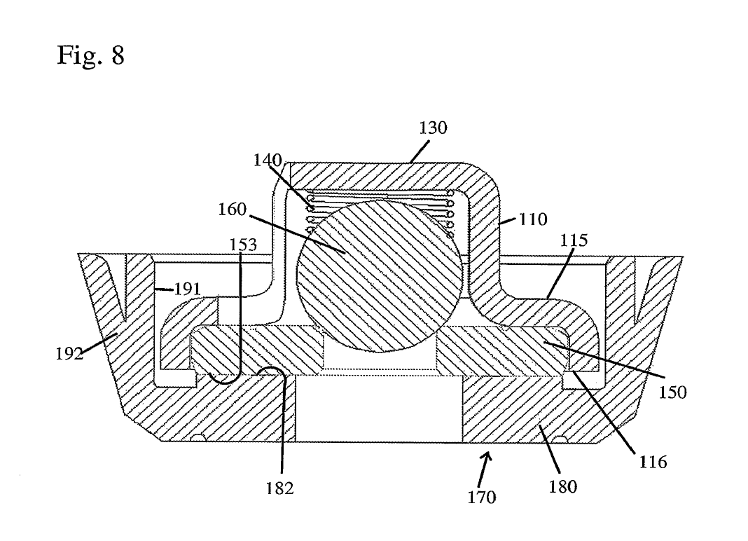

FIG. 8 shows a fourth embodiment of the hydraulic check valve assembly 170 in which the hydraulic check valve 110 is not secured to the seal housing 180 by any of the means previously shown. The secure abutment of the annular sealing surface 182 to the outer annular surface 153 of the ball seat 150 is achieved by the tensioner spring (not shown) forcefully urging the annular flange 115 of the retainer 110 to abut the seal housing 180.

With respect to the fourth embodiment, in the absence of the force exerted by the tensioner coil spring, the retainer 110 would float with respect to the ball seat 150 and, in turn, the ball seat would float with respect to the seal housing 180. In this regard, the preferred embodiments of the hydraulic check valve assembly of the invention are the first embodiment, as shown in FIG. 5, and the fourth embodiment, as shown in FIG. 8. The first embodiment is the most preferred.

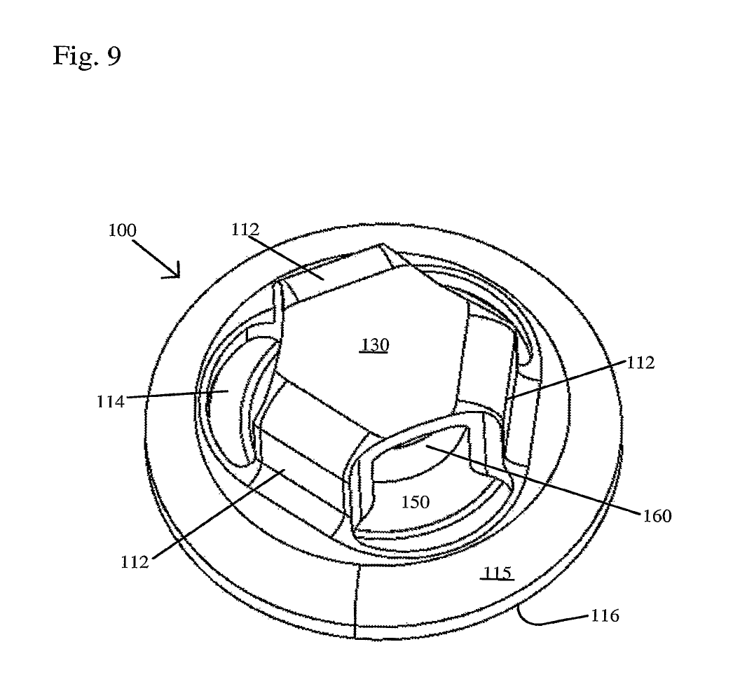

FIG. 9 shows an isometric view of the hydraulic check valve 100. From this perspective, one can see that the extension of the upper portions of the gaps 114 onto the surface of the vertex 130 creates a generally triangular shape. The bottom ends of the gaps 114 do not extend onto the surface of the annular flange 115, which provides an uninterrupted seat for one end of the tensioner coil spring (not shown).

FIG. 10 provides an isometric view of the hydraulic check valve of FIG. 9 installed within a seal housing 180 to form the hydraulic check valve assembly 170 of the invention. In this embodiment, the hydraulic check valve is secured within the seal housing 180 by segmented annular lips 190.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A hydraulic check valve comprising:
a) a retainer having at least two peripheral walls disposed along a longitudinal axis of the hydraulic check valve defining a hollow internal chamber, the retainer having a first end and a second end, wherein the first end forms a vertex,
b) a gap formed between each of the peripheral walls,
c) a coil spring disposed within the hollow internal chamber, a first end of the coil spring abutting the vertex,
d) a ball seat located at the second end of the retainer and substantially perpendicular to the longitudinal axis of the retainer, the ball seat having an inner annular surface, an outer annular surface and a centrally located passage, and
e) a ball disposed within the hollow internal chamber between a second end of the coil spring and the internal annular surface of the ball seat,
wherein the ball contacts a single point on an internal surface of one or more of the peripheral walls as it traverses along the longitudinal axis of the retainer.

2. The hydraulic check valve of claim 1 wherein there are three peripheral walls.

3. The hydraulic check valve of claim 1 wherein one end of each gap extends onto the vertex.

4. The hydraulic check valve of claim 3 wherein the vertex is substantially triangular shaped.

5. The hydraulic check valve of claim 1 wherein hydraulic fluid flows through the centrally located passage of the ball seat into the hollow internal chamber and out through the gaps with minimal impedance.

6. The hydraulic check valve of claim 1 wherein the peripheral walls are planar.

7. The hydraulic check valve of claim 1 wherein the peripheral walls are convex having a radius that is larger than the radius of the ball.

8. A hydraulic check valve assembly comprising:
a) a retainer having at least two peripheral walls disposed along a longitudinal axis of the check valve defining a hollow internal chamber, the retainer having a first end and a second end wherein the first end forms a vertex and the second end forms an annular flange having an external surface and an internal surface,
b) a gap formed between each of the peripheral walls,
c) a coil spring disposed within the hollow internal chamber, a first end of the coil spring abutting the vertex,
d) a ball seat located at the second end of the retainer and perpendicular to the longitudinal axis, the ball seat having an inner annular surface abutting the internal surface of the annular flange, an outer annular surface and a centrally located passage,
e) a ball disposed within the hollow internal chamber between a second end of the coil spring and the internal annular surface of the ball seat, and
f) a seal having an annular sealing surface abutting the outer annular surface of the ball seat,
wherein the ball contacts a single point on an internal surface of one or more of the peripheral walls as it traverses along the longitudinal axis of the retainer.

9. The hydraulic check valve of claim 8 wherein there are three peripheral walls.

10. The hydraulic check valve of claim 8 wherein one end of each of the gaps extends onto the vertex.

11. The hydraulic check valve assembly of claim 10, wherein the vertex is substantially triangular shaped.

12. The hydraulic check valve assembly of claim 8, wherein the peripheral walls are planar.

13. The hydraulic check valve assembly of claim 8 wherein the walls are convex having a radius that is larger than the radius of the ball.

14. The hydraulic check valve assembly of claim 8 wherein the annular sealing surface of the seal loosely abuts the outer annular surface of the ball seat.

15. The hydraulic check valve assembly of claim 8, wherein the inner annular surface of the ball seat loosely abuts the internal surface of the annular flange.
